(19) United States
(12) Patent Application Publication
(10) Pub. No.: US 2024/0274871 A1
(43) Pub. Date: Aug. 15, 2024

(54) BIODEGRADABLE ELECTROCHEMICAL DEVICE AND METHODS THEREOF

(71) Applicant: XEROX CORPORATION, NORWALK, CT (US)

(72) Inventors: Gregory McGuire, Ontario (CA); Naveen Chopra, Ontario (CA); Aleksa Dovijarski, Ontario (CA); Nan-Xing Hu, Ontario (CA)

(73) Assignee: XEROX CORPORATION, NORWALK, CT (US)

(21) Appl. No.: 18/163,654

(22) Filed: Feb. 2, 2023

(51) Int. Cl. H01M 10/0565; H01M 10/04; H01M 10/28

(52) U.S. Cl. CPC H01M 10/0565; H01M 10/0468; H01M 10/281; H01M 2300/0082; H01M 2300/0085

(57) ABSTRACT

An electrochemical device is disclosed. The electrochemical device includes an anode and a cathode, and a cured electrolyte composition disposed between the anode and the cathode, where at least a portion of the electrolyte composition interpenetrates at least a portion of both the anode and the cathode. A stacked geometry electrochemical device is disclosed. The stacked geometry electrochemical device includes a first electrode and a second electrode, and a cured electrolyte composition defining a top surface in contact with the first electrode, a bottom surface in contact with the second electrode, and a peripheral edge not in contact with the first electrode and the second electrode. The device also includes a mold wall disposed at the peripheral edge surrounding and contacting the cured electrolyte composition, where at least a portion of the mold wall is transmissible to curing radiation. A method of producing an electrolyte layer of an electrochemical device is also disclosed.

### TECHNICAL FIELD

The present teachings relate generally to biodegradable electrochemical devices, electrolytes thereof, and fabrication methods for the same.

### BACKGROUND

The number of batteries being produced in the world is continuously increasing as a consequence of the growing need for portable and remote power sources. Particularly, a number of new technologies require batteries to power embedded electronics. For example, embedded electronics, such as portable and wearable electronics, Internet of Things (IoT) devices, patient healthcare monitoring, structural monitoring, environmental monitoring, smart packaging, or the like, rely on batteries for power. While conventional batteries may be partially recycled, there are currently no commercially available batteries that are environmentally friendly or biodegradable. As such, an increase in the manufacture and use of conventional batteries results in a corresponding increase in toxic and harmful waste in the environment if not properly disposed of or recycled. In view of the foregoing, there is a need to develop improved biodegradable batteries: especially for applications that utilize disposable batteries for a limited time before being discarded.

Further, to meet the demand for flexible, low-cost, medium or low performance batteries, all-printed batteries have been developed. Some of these all-printed batteries use a GPE (gel polymer electrolyte) in lieu of a paper or fleece material soaked with aqueous solution. Advantages of a GPE layer include ease of manufacturing, improved structural integrity, flexibility, and more consistent performance. A GPE layer may integrate well in a manufacturing process including integrated processing and offer potential advantages in reducing production costs. Current methods of screen printing the curable GPE material are challenged by issues such as non-uniform thickness, inadequate pile height, and air bubbles in the film. Non-uniform thickness may lead to buckling in all-printed battery structure. Inadequate pile height in a battery may lead to short circuits, and air bubbles in the film may result in poor film uniformity in the battery structure and irregular performance.

There is a need for processes to create biodegradable gel polymer electrolyte layer with good fidelity attributes, including gel polymer electrolyte layers exhibiting bubble-free, adequate thickness, fully cured, sufficiently adherent, and uniform pile height properties, and batteries made using such processes.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

An electrochemical device is disclosed. The electrochemical device includes an anode and a cathode. The electrochemical device also includes a cured electrolyte composition disposed between the anode and the cathode, where at least a portion of the electrolyte composition interpenetrates at least a portion of both the anode and the cathode, and the cathode and the anode exhibits a stacked geometry. Implementations of the electrochemical device may include where the cured electrolyte composition is a single layer without an interface. The cured electrolyte composition may include a gel polymer electrolyte. The gel polymer electrolyte may include a hydrogel of a copolymer and a salt dispersed in the hydrogel of a copolymer. The cured electrolyte composition may include a biodegradable electrolyte composition. The cured electrolyte composition may include an aqueous-based electrolyte composition. The cured electrolyte composition may include a non-aqueous electrolyte composition. The cured electrolyte composition further may include a lithium salt. The cured electrolyte composition may include an organic electrolyte composition.

A stacked geometry electrochemical device is disclosed. The stacked geometry electrochemical device includes a first electrode and a second electrode. The stacked geometry electrochemical device also includes a cured electrolyte composition defining a top surface in contact with the first electrode, a bottom surface in contact with the second electrode, and a peripheral edge not in contact with the first electrode and the second electrode. The device also includes a mold wall disposed at the peripheral edge surrounding and contacting the cured electrolyte composition, where at least a portion of the mold wall is transmissible to curing radiation. Implementations of the stacked geometry electrochemical device may include where the cured electrolyte composition is a single layer without an interface. The cured electrolyte composition may include a gel polymer electrolyte. The cured electrolyte composition may include a biodegradable, aqueous-based electrolyte composition. The cured electrolyte composition may include a non-aqueous, organic electrolyte composition.

A method of producing an electrolyte layer of an electrochemical device is disclosed, including employing a mold wall to define a cavity having an open top and a bottom bounded by a first electrode, where at least a portion of the mold wall is transmissible to a curing radiation. The method also includes filling the cavity with an electrolyte pre-cure composition where the first electrode absorbs a first portion of the electrolyte pre-cure composition. The method also includes applying a second electrode to cover the top of the cavity filled with the electrolyte pre-cure composition, where the second electrode absorbs a second portion of the electrolyte pre-cure composition. The method also includes subjecting the electrolyte pre-cure composition to a curing radiation via the portion of the mold wall transmissible to the curing radiation to initiate crosslinking of the electrolyte pre-cure composition to form a cured electrolyte composition. Implementations of the method of producing an electrolyte layer of an electrochemical device may include where the curing radiation may include ultraviolet radiation. The mold wall scatters or internally reflects ultraviolet radiation towards the cavity. The mold wall may include a source that produces curing radiation. The method of producing an electrolyte layer of an electrochemical device may include applying a uniform pressure to a top surface of the second electrode prior to subjecting the electrolyte pre-cure composition to the curing radiation, removing the uniform pressure applied to the top surface of the second electrode after forming the cured electrolyte composition, and removing the one or more mold walls from the substrate. The electrolyte pre-cure composition may include a gel polymer electrolyte, may include a hydrogel of a copolymer and a salt dispersed in the hydrogel of a copolymer.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 illustrates an exploded view of an exemplary electrochemical device in a stacked configuration, in accordance with the present disclosure.

FIG. 2 illustrates a schematic of a process for providing a gel polymer electrolyte layer for an electrochemical device, in accordance with the present disclosure.

FIG. 3 is a schematic of an array of molded gel polymer electrolyte layer for an electrochemical device, in accordance with the present disclosure.

FIGS. 4A-4B illustrate a first process and set up for producing an electrolyte layer of an electrochemical device, in accordance with the present disclosure.

FIGS. 5A-5B illustrate a second process and set up for producing an electrolyte layer of an electrochemical device, in accordance with the present disclosure.

FIGS. 6A-6B illustrate a third process and set up for producing an electrolyte layer of an electrochemical device, in accordance with the present disclosure.

FIG. 7 is a flowchart illustrating a method for producing an electrolyte layer of an electrochemical device, in accordance with the present disclosure.

FIG. 8 is a plot depicting OCV change over time of Comparative Example and Example 2, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The following description of various typical aspect(s) is merely exemplary in nature and is in no way intended to limit the disclosure, its application, or uses.

As used throughout, ranges are used as shorthand for describing each and every value that is within the range. Any value within the range may be selected as the terminus of the range. In addition, all references cited herein are hereby incorporated by reference in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

As used herein, the term “or” is an inclusive operator, and is equivalent to the term “and/or,” unless the context clearly dictates otherwise. The term “based on” is not exclusive and allows for being based on additional factors not described, unless the context clearly dictates otherwise. In the specification, the recitation of “at least one of A, B, and C,” includes examples containing A, B, or C, multiple examples of A, B, or C, or combinations of A/B, A/C, B/C, A/B/B/B/B/C, A/B/C, etc. In addition, throughout the specification, the meaning of “a,” “an,” and “the” include plural references. The meaning of “in” includes “in” and “on.”

Reference will now be made in detail to exemplary examples of the present teachings, examples of which are illustrated in the accompanying drawings. Wherever possible, the same reference numbers will be used throughout the drawings to refer to the same, similar, or like parts.

A biodegradable electrochemical device is disclosed herein. As used herein, the term “biodegradable” or “biodegradable material” may refer to a material, component, substance, device, or the like, capable of or configured to be decomposed by living organisms, particularly microorganisms in a landfill within a reasonable amount of time. The material, component, substance, device, or the like may be decomposed into water, naturally occurring gases like carbon dioxide and methane, biomass, or combinations thereof. As used herein, the expression “biodegradable electrochemical device” or “biodegradable device” may refer to an electrochemical device or a device, respectively, where at least one or more components thereof is biodegradable. In some instances, a majority or substantial number of the components of the biodegradable electrochemical device or the biodegradable device are biodegradable. In other instances, all of the polymer components of the biodegradable electrochemical device or the biodegradable device are biodegradable. For example, the polymers and/or other organic-based components of the electrochemical device are biodegradable while the inorganic materials of the electrochemical device disclosed herein, including the metals and/or metal oxides, may not be biodegradable. It should be appreciated that if all polymer and/or organic-based components of an electrochemical device are biodegradable, it is generally accepted that the complete electrochemical device is considered biodegradable. As used herein, the term “compostable” may refer to items that are able to be made into compost or otherwise disposed of in a sustainable or environmentally friendly manner. Compostable materials may be considered to be a subset category of biodegradable materials wherein additional specific environmental temperatures or conditions may be needed to break down a compostable material. While the term compostable is not synonymous with biodegradable, they may be used interchangeably in some instances, wherein the conditions necessary to break down or decompose a biodegradable material are understood to be similar to the conditions necessary to break down a compostable material. As used herein, the term or expression “electrochemical device” may refer to a device that converts electricity into chemical reactions and/or vice-versa. Illustrative electrochemical devices may be or include, but are not limited to, batteries, die-sensitized solar cells, electrochemical sensors, electrochromic glasses, fuel cells, electrolysers, or the like.

As used herein, the term or expression “environmentally friendly electrochemical device” or “environmentally friendly device” may refer to an electrochemical device or device, respectively, that exhibits minimal, reduced, or no toxicity to the ecosystems or the environment in general. In at least one embodiment, the electrochemical devices and/or components thereof disclosed herein are environmentally friendly.

As used herein, the term or expression “film” or “barrier layer” may refer to a thin, partially or substantially plastic and/or polymeric material that may be used in various electrochemical device components or parts, including, but not limited to substrates, connections, enclosures, barriers, or combinations thereof. Films as described herein may be rigid or flexible, depending upon the inherent physical properties or dimensions of their respective compositions. In at least one embodiment, these films or barrier layers may be environmentally friendly or biodegradable

As used herein, the term or expression “enclosure,” “barrier,” or “water vapor barrier” may refer to materials utilized in partially sealed, fully sealed or otherwise used to prevent moisture, water or other evaporable materials from entering or exiting via the barrier of an electrochemical device. In at least one embodiment, these enclosures may be environmentally friendly or biodegradable.

In at least one embodiment, the electrochemical device disclosed herein may include an anode, a cathode (i.e., a current collector and/or an active layer), and one or more electrolyte compositions (e.g., a biodegradable solid aqueous electrolyte composition). In another embodiment, the biodegradable electrochemical device may further include one or more substrates, one or more seals, one or more packages, one or more pouches, one or more enclosures, or combinations thereof.

The electrochemical devices disclosed herein may be flexible. As used herein, the term “flexible” may refer to a material, device, or components thereof that is capable of being bent around a predetermined radius of curvature without breaking and/or cracking. The biodegradable electrochemical devices and/or the components thereof disclosed herein may be bent around a radius of curvature of about 30 cm or less, about 20 cm or less, about 10 cm or less, about 5 cm or less without breaking or cracking.

In certain fabrication processes related to biodegradable electrochemical devices, poor adhesion can result from manual assembly steps. To overcome the poor adhesion on the manually assembled sides or other areas of the battery or electrochemical devices, the tackiness of cured polymer gel electrolyte pad can be modified by tailoring electrolyte material formulation. Alternatively, molding the polymer gel electrolyte pads onto both electrode sides before assembling the battery can be used, but has the draw back of doubling the thickness of the electrolyte and in turn reducing the current output. It also still relies on the tackiness of the electrolyte pad surface to form a uniform strong bond with the alternate electrolyte pad surface.

As described above, there can be poor adhesion when the electrode and the cured polymer gel electrolyte pad are manually applied to each other, as found in previously known methods in the art, and this leads to poor battery performance. The present teachings overcome this problem by implementing an in-situ curing process where the polymer electrolyte pre-cure solution is cured into a gel pad after battery electrode assembly has already taken place. A pre-cure solution can be defined as an electrolyte solution in a liquid state prior to curing and being crosslinked into a gel state electrolyte pad. To enable this process, ultraviolet (UV) light can be directed or guided to pass through the pre-cure solution from one or more open edges of the assembled electrode stack and then internally through the assembled battery to crosslink the pre-cure solution. This results in a mold wall itself becoming or allowing transmission of the light source for curing the pre-cure solution into a polymer electrolyte gel pad. This method further allows the pre-cure solution to soak into the electrode active material on both sides of the battery before curing into a solid gel. This produces a high adhesion strength between the active electrode material and the polymer gel electrolyte material due to crosslinked material interpenetration into both electrodes on both sides of the electrochemical device. As both sides of the battery in a stacked geometry configuration are exposed to liquid pre-cured electrolyte that soaks into the active layers before curing, this method provides good adhesion on both sides of the battery or electrochemical device. Several examples reflecting the present teachings are described herein. These examples include a similar principle of operation, in that a mold wall used in the electrolytic device fabrication process becomes or allows transmission of a light source in order to radiatively cure the polymer gel electrolyte in-situ. A mold wall allowing transmission of a curing light or curing radiation includes one that can allow light or radiation into the electrochemical device cavity to contact the electrolyte solution or electrolyte pre-cure solution and provide an initiation of a crosslinking reaction to form a gel electrolyte material within the electrochemical device. Examples of such curing light or curing radiation mold walls are described in the present teachings.

The radiatively curable polymer gel electrolyte can be applied using a molding technique in previously known methods. In these prior methods, a mold is first applied to one of either the anode electrode, or cathode electrode. A pre-cure viscous solution of polymer, water, salts, and photoinitiator is then applied within the mold and sealed under a release layer and a heavy glass top panel, and then radiatively cured to form a gel pad. Once cured, the alternate electrode, either cathode or anode, without any gel is manually applied to the surface of the cured gel to fully assemble the battery. This method can sometimes lead to weak adhesion on the manually assembled side, and loss of open circuit voltage (OCV), and eventually battery failure.

The present teachings provide an electrochemical device including an anode, a cathode, and an electrolyte composition disposed between the anode and the cathode wherein at least a portion of the electrolyte composition interpenetrates at least a portion of the anode or the cathode or both the anode and the cathode. This interpenetration of the electrolyte composition into one or more of the electrodes provides a more robust structure for the electrochemical device. A method of producing the electrolyte layer for the electrochemical device including preparing a substrate for an electrochemical device, the substrate having an electrode, preparing a gasket, which may be alternately referred to as a mold wall, to form a cavity on the substrate for the electrolyte layer, depositing an electrolyte composition onto the substrate, in contact with the electrode such that the cavity is filled to a top surface of the gasket and at least a portion of the electrolyte composition absorbs into at least a portion of the electrode, applying a release layer onto a top surface of the gasket and a top surface of the deposited electrolyte composition, applying a uniform pressure to a top surface of the release layer, and subjecting the electrolyte composition to ultraviolet radiation to initiate crosslinking of the electrolyte composition can provide such an electrochemical device and an improved electrolyte composition.

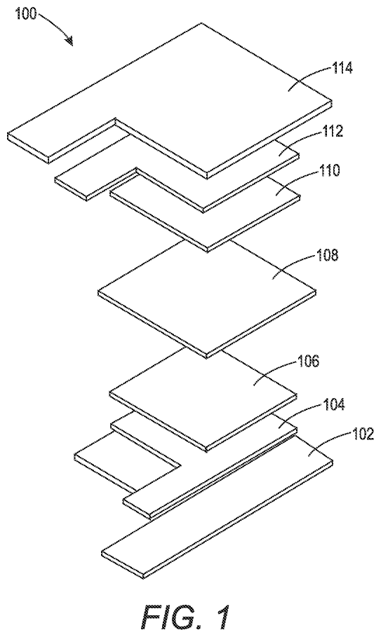

FIG. 1 illustrates an exploded view of an exemplary electrochemical device in a stacked configuration, in accordance with the present disclosure. As illustrated in FIG. 1, the electrochemical device 100 may include a first substrate 102, a first current collectors 104 disposed adjacent to or on top of the first substrate 102, an anode active layer 106 disposed adjacent to or on top of the first current collector 104, an electrolyte layer 108 disposed adjacent to or on top of the anode 106, a cathode active layer 110 disposed adjacent to or on top of the electrolyte composition 108, a second current collector 112 disposed adjacent to or on top of the cathode active layer 110, and a second substrate 114 disposed adjacent to or on top of the second current collector 112. It should be appreciated that the first current collector 104 and the anode active layer 106 may be collectively referred to herein as an anode of the electrochemical device 100. It should further be appreciated that the second current collector 112 and the cathode active layer 110 may be collectively referred to herein as a cathode of the electrochemical device 100. As illustrated in FIG. 1, the anode and the cathode of the electrochemical device 100 may be arranged in a stacked configuration or stacked geometry such that the anode and the cathode are disposed on top of or below one another.

In certain examples, the electrochemical device 100 may include one or more seals, not shown here, capable of or configured to hermetically seal the current collectors 104, 106, the anode active layer 106, the cathode active layer 110, and the electrolyte composition 108 between the first and second substrates 102, 114 of the electrochemical device 100. In another example, the electrochemical device 100 may be free or substantially free of seals, as shown in FIG. 1. For example, the substrates 102, 114 may be melted or bonded with one another to seal the electrochemical device 100. In still other examples, each of the current collectors 104, 106, may include a respective tab that may extend outside the body of the electrochemical device 100 to thereby provide connectivity. In some examples, the electrochemical device 100 may be arranged in a side-by-side or coplanar configuration. Further, the anode and the cathode of the electrochemical device 100 may be coplanar such that the anode and the cathode are arranged along the same X-Y plane.

In at least one example, any one or more of the substrates of the electrochemical device 100 may be or include, but is not limited to, a biodegradable substrate. Illustrative biodegradable substrates may be or include, but are not limited to, one or more of polylactic acid (PLA), polylactic-co-glycolic acid (PLGA), silk-fibroin, chitosan, polycaprolactone (PCL), polyhydroxy butyrate (PHB), rice paper, cellulose, or combinations or composites thereof.

The biodegradable substrates of the respective biodegradable electrochemical devices 100 may be stable at temperatures of from about 50° ° C. to about 150° ° C. As used herein, the term “stable” or “stability” may refer to the ability of the substrate to resist dimensional changes and maintain structural integrity when exposed to temperature of from about 50° C. to about 150° C. For example, the biodegradable substrates may be capable of or configured to maintain structural integrity with dimensional changes of less than about 20%, less than about 15%, or less than about 10% after exposure to temperatures of from about 50° C. to about 150° C. In one example, each of the biodegradable substrates may be stable (e.g., dimensional changes less than 20%) at a temperature of from about 50° ° C., about 60° C., about 70° C., about 80° C., about 90° C., about 100° C., or about 110° C. to about 120° C., about 130° C., about 140° C., or about 150° C. In another example, each of the biodegradable substrates may be stable at a temperature of at least 100° C., at least 105° C., at least 110° C., at least 115° C., at least 120° C., at least 125° C., at least 130° C., at least 135° C., at least 140° C., or at least 145° C. In at least one embodiment, the biodegradable substrates may be stable at temperatures of from about 50° ° C. to about 150° C. for a period of from about 5 min to about 60 min or greater. For example, the biodegradable substrates may be stable at the aforementioned temperatures for a period of time from about 5 min, about 10 min, about 20 min, or about 30 min to about 40 min, about 45 min, about 50 min, about 60 min, or greater.

In at least one embodiment, the biodegradable substrate is weldable, bondable, and/or permanently thermo-scalable without the use of an additional adhesive. For example, the biodegradable substrates of each of the substrates 102, 114 may be weldable and/or bondable with one another without the use of respective seals. Illustrative biodegradable substrates that may be weldable and/or bondable with one another may be or include, but are not limited to, thermoplastics, such as polylactic acid (PLA), polylactides modified with a nucleating agent to enhance crystallinity, such as polylactide polybutylene succinate (PBS), polybutylene adipate terephthalate (PBAT), blends of PLA and polyhydroxybutyrate (PHB), PHB-based blends, or the like, or combinations thereof. As used herein, the term or expression “bondable,” “weldable,” and/or “permanently thermo-scalable” may refer to an ability of a material (e.g., substrate) to heat seal two surfaces with one another or permanently join two surfaces with one another via heating or melting.

The anode active layer 106 of exemplary biodegradable electrochemical devices 100 may be or include, but are not limited to, one or more of zinc (Zn), lithium (Li), carbon (C), cadmium (Cd), nickel (Ni), magnesium (Mg), magnesium alloys, zinc alloys, or the like, or combinations and/or alloys thereof. Illustrative anode active layers or materials thereof may be or include, but are not limited, or the like, or combinations thereof. In at least one embodiment, the anode active layer may include zinc oxide (ZnO) in a sufficient amount to regulate or control H₂ gassing.

In at least one example, the anode active layer 106 of exemplary biodegradable electrochemical devices 100 may be prepared or fabricated from an anode paste. For example, the anode active layer may be prepared from a zinc anode paste. The anode paste may be prepared in an attritor mill. In at least one embodiment, stainless steel shot may be disposed in the attritor mill to facilitate the preparation of the anode paste. The anode paste may include one or more metal or metal alloys, one or more organic solvents, one or more styrene-butadiene rubber binders, or combinations thereof. In an exemplary embodiment, the anode paste may include one or more of ethylene glycol, a styrene-butadiene rubber binder, zinc oxide (ZnO), bismuth (III) oxide (Bi₂O₃), Zn dust, or combinations thereof. Illustrative organic solvents are known in the art and may be or include, but are not limited to, ethylene glycol, acetone, NMP, or the like, or combinations thereof. In at least one embodiment, any one or more biodegradable binders may be utilized in lieu of or in combination with a styrene-butadiene rubber binder and may include, but are not limited to, Alginate, Chitosan, Guar gum, Gluten, and the like.

The cathode active layer 110 of exemplary biodegradable electrochemical devices 100 may be or include, but are not limited to, one or more of iron (Fe), iron (VI) oxide, mercury oxide (HgO), manganese (IV) oxide (MnO₂), carbon (C), carbon-containing cathodes, gold (Au), molybdenum (Mo), tungsten (W), molybdenum trioxide (MoO₃), silver oxide (Ag₂O), copper (Cu), vanadium oxide (V₂O₅), nickel oxide (NiO), copper iodide (Cu₂I₂), copper chloride (CuCl), or the like, or combinations and/or alloys thereof. In an exemplary example, the cathode active layer 110 may include manganese (IV) oxide. The carbon and/or carbon-containing cathode active layers may be utilized in aqueous metal-air batteries, such as zinc air batteries.

In at least one example, the cathode active layer 110 may include one or more additives capable of or configured to at least partially enhance the electronic conductivity of the cathode active layer 110. Illustrative additives may be or include, but are not limited to, carbon particles, such as graphite, carbon nanotubes, carbon black, or the like, or the like, or combinations thereof.

In at least one example, the cathode active layer 110 of an exemplary biodegradable electrochemical device 100 may be prepared or fabricated from a cathode paste. For example, the cathode active layer 110 may be prepared from a manganese (IV) oxide cathode paste. The cathode paste may be prepared in an attritor mill. In at least one example, stainless steel shot may be disposed in the attritor mill to facilitate the preparation of the cathode paste. The cathode paste may include one or more metal or metal alloys, one or more organic solvents (e.g., ethylene glycol), one or more styrene-butadiene rubber binders, or combinations thereof. In an exemplary example, the cathode paste may include one or more of ethylene glycol, a styrene-butadiene rubber binder, manganese (IV) oxide (MnO₂), graphite, or combinations thereof. Illustrative organic solvents are known in the art and may be or include, but are not limited to, ethylene glycol, acetone, NMP, or the like, or combinations thereof. In at least one example, the one or more organic solvents may be replaced or used in combination with an aqueous solvent, such as water. For example, water may be utilized in combination with manganese (IV) oxide or other additives.

Once these electrode layers are formed, there can still exist interstitial spaces or inherent porosity within the bulk of the electrode layer that can be displaced by at least a portion of the electrolyte layer when fabricated according to the present teachings. This impregnation or interpenetration of the electrolyte material into the electrode material can provide improved adhesion and improved contact between components of an electrochemical device. This concept can apply to various binders, cathode paste, anode paste, active layer material, or a combination thereof, provided these materials are in contact with the electrolyte composition. Once the electrolyte pre-cure contacts the roughened surfaces of the electrodes, and is cured in situ, the intimate interaction of crosslinked electrolyte with the electrode, would result in an interlayer boundary where any efforts to peel apart the device would result in destruction and ‘tearing apart’ of the electrode due to the stronger cohesive bond. This is in contrast with a separately cured electrolyte which would likely result in cohesive failure, and the layer would cleanly peel away from the electrode with minimal impact.

In at least one embodiment, each of the anodes and the cathodes, or the active layers 106, 110 thereof may independently include a biodegradable binder. The function of the biodegradable binder is to anchor the particles of each of the respective layers together and provide adhesion to the substrate underneath, the respective layers being the anode current collector 104, the cathode current collector 112 the anode active layer 106, the cathode active layer 110, or combinations thereof. Illustrative biodegradable binders may be or include, but are not limited to, one or more of chitosan, polylactic-co-glycolic acid (PLGA), gelatin, xanthan gum, cellulose acetate butyrate (CAB), polyhydroxybutyrate (PHB), alginate, derivatives of alginate, such as M-alginate, or a combination thereof. In at least one embodiment, any one or more of the biodegradable polymers disclosed herein with regard to the electrolyte composition may also be utilized as the biodegradable binder of the anode, the cathode, components thereof, or any combination thereof. As further described herein, the one or more biodegradable polymers may be cross-linked. As such, the biodegradable binders utilized for the anode, the cathode, and/or the components thereof, may include the cross-linked biodegradable binders disclosed herein with regard to the electrolyte composition.

The electrolyte layer 108 of exemplary biodegradable electrochemical devices 100 may be or include an electrolyte composition. The electrolyte composition may utilize biodegradable polymeric materials. The electrolyte composition may be a solid, aqueous electrolyte composition. The solid, aqueous electrolyte composition may be or include a hydrogel of a copolymer and a salt dispersed in and/or throughout the hydrogel. The copolymer may include at least two polycaprolactone (PCL) chains attached with a polymeric center block (CB). For example, the copolymer may be a block copolymer or a graft copolymer including at least two PCL chains coupled with the polymeric center block, such as PCL-CB-PCL. In another example, the copolymer may be a block copolymer or a graft copolymer including at least one or more of polylactic acid (PLA), polyglycolic acid (PGA), polyethylene imine (PEI) or combinations thereof, coupled with the polymeric center block.

The copolymer or the solids may be present in the hydrogel in an amount of from about 5 weight % or greater to 90 weight % or less, based on a total weight of the hydrogel (e.g., total weight of solvent, polymer, and salt). For example, the copolymer may be present in an amount of from about 5 weight % or greater, 10 weight % or greater, 15 weight % or greater, 20 weight % or greater, 25 weight % or greater, 30 weight % or greater, 35 weight % or greater, based on a total weight of the hydrogel. In another example, the copolymer may be present in an amount of from 90 weight % or less, 80 weight % or less, 70 weight % or less, or 60 weight % or less, based on a total weight of the hydrogel. In a preferred embodiment, the copolymer or the solids may be present in the hydrogel in an amount of from about 5 weight % to about 60 weight %, about 5 weight % to about 50 weight %, about 20 weight % to about 40 weight %, or about 30 weight %, based on a total weight of the hydrogel. In yet another preferred embodiment, the copolymer or the solids may be present in the hydrogel in an amount of from greater than 30 weight % to 60 weight %, based on a total weight of the hydrogel.

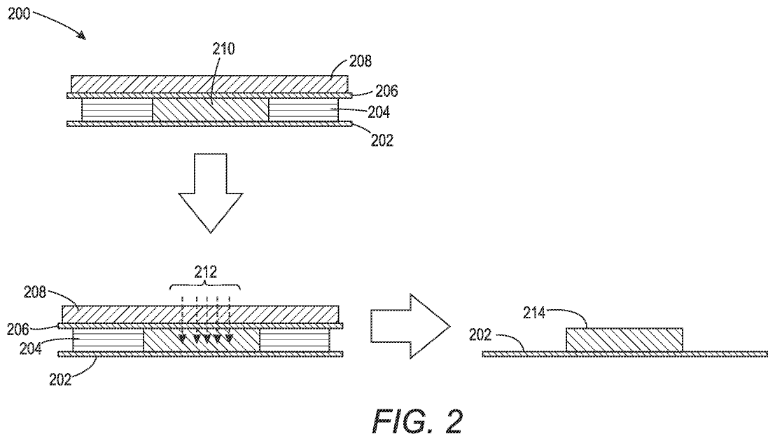

FIG. 2 illustrates a schematic of a process for providing a gel polymer electrolyte layer for an electrochemical device, in accordance with the present disclosure. The process shown in FIG. 2 is an exemplary example of an electrolyte forming process 200 for compostable or biodegradable batteries using a molding process. The molding process is scalable and is an efficient method for reproducibly creating cured gel electrolyte layers with high fidelity, reduced defects, such as bubbles, and uniform pile height. The process may be extended to non-compostable curable gel electrolyte compositions as well, for example polyacrylic acid. The electrolyte forming process 200 begins with a substrate 202 prepared for use in an electrochemical device, which may include additional structural layers such as anodes, cathodes, and seals as described herein. It should be noted that the substrate 202 is shown without these additional layers for the purposes of clarity. As shown in cross-section, the sides of a gasket 204 are placed on a top surface of the substrate. The shape and form of the gasket should be understood to be in a geometrical arrangement or shape intended for a gel polymer electrolyte layer 210 to be deposited on the surface of the substrate 202. The gasket 204 may also be referred to as a spacer layer, mold, or guide and applied over a substrate and electrode, for example, a zinc electrode. In an exemplary example, a 700-micron thick rubber sheet is used to create a 4 cm×4 cm screen print with 5025 silver ink, using a 180-mesh screen and 80 durometer squeegee, which is cured at 100° C. for 10 minutes. The 4 cm×4 cm silver square was then cut out using an X-Acto® precision blade to create a mold gasket as shown. A release agent is used to provide a release surface between the gasket 204 and the gel polymer electrolyte layer 210 to prevent sticking when the gasket 204 is later removed. In exemplary examples, Silsurf A208 silicone glycol copolymer can be applied to the inside edges of the molded rubber gasket 204 by lightly wiping with a cotton-tip swab. The mold is placed over the battery electrode substrate 202. Gel polymer electrolyte 210 solution is poured into the center of the mold in a sufficient quantity to fill the cavity created by the substrate 202 and the gasket 204. Once a portion of the gel polymer electrolyte layer 210 is deposited into a cavity, well, or void created by the gasket 204, a release layer sheet 206 is placed on top of the gasket 206 and gel polymer electrolyte layer 210. In an example, a bare sheet of PLA as a release layer 206 is placed over the filled mold in a rolling manner to eliminate entrapped air pockets. Next, a pressure plate 208, for example, one or more sheets of heavy glass, are placed over the mold and release layer sheet 206 to apply enough pressure on the mold to seal it onto the substrate 202 and spread the gel polymer electrolyte 210 solution into the mold. While glass is used in this example, any sufficiently transparent material capable of being applied to form pressure onto the gasket mold 204 would be suitable, which may include, but not be limited to transparent polymer or plastic, such as polycarbonate. The gel polymer electrolyte 210 is allowed to spread and fill the mold completely before curing. Certain examples may include a radiation curable gel polymer electrolyte composition, which would require a transparent pathway provided by a transmissive release layer sheet 206 and pressure plate 208 for the radiation to penetrate the gel polymer electrolyte during curing to initiate and complete curing via radiation. Curing energy 212 radiation, such as ultraviolet, infrared, or thermal elevation or thermal energy is then transmitted through or alternatively, around the pressure plate 208 to produce a cured or crosslinked gel polymer electrolyte 214. In an example, curing can be accomplished using a Fusion 16W 395 nm LED lamp at a 10-inch height for a 1000 millisecond duration. Once the one or more pressure plates 208 are removed, the release layer sheet 206 may be carefully removed in a slow rolling manner, and the gasket 204 removed to furnish the cured polymer electrolyte layer on the substrate 202. In this manner, gel polymer electrolyte layers having a thickness of from about 50 microns to about 700 microns may be produced. The thickness and physical properties of the gasket 204 used in the procedure and the amount of pressure applied contribute to a final thickness of the gel polymer electrolyte 210. Following the molding and curing steps, a second electrode, for example, one comprised of manganese dioxide, can be applied manually to the cured gel polymer electrolyte 210.

An exemplary formulation of gel polymer electrolyte may include the following composition. A gel polymer electrolyte composition was prepared in water, as shown in Table 1.

TABLE 1
Gel Polymer Electrolyte composition

| Component | Mass (g) | % by weight |
|---|---|---|
| GPE polymer | 18 | 31.0 |
| Electrolyte (salt in water) | 40 | 68.9 |
| LAP (photoinitiator) | 0.04 | 0.06 |
| TOTAL | 58.04 | 100.0 |

The GPE polymer is a graft polymer with the generic structure shown below:

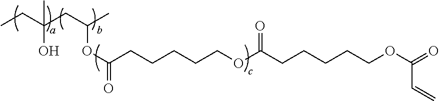

An exemplary example of a GPE polymer is a PVA main polymer chain, with PCL side pendant groups or side chains as shown in the structure below:

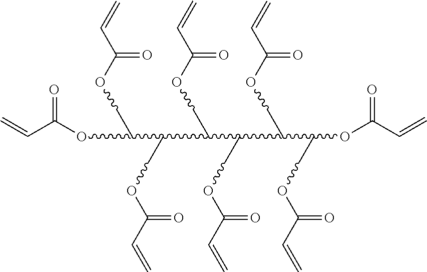

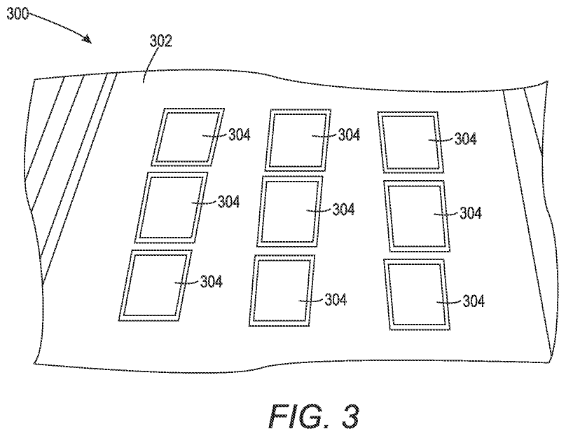

FIG. 3 is a schematic of an array of extruded gel polymer electrolyte layer for an electrochemical device, in accordance with the present disclosure. The array 300 illustrates the end result of a process utilizing a method of electrolyte composition deposition similar to that shown in FIG. 2, arranged in an array 300 of portions of gel polymer electrolyte layers 304. As shown, a substrate 302 is shown having a plurality of gel polymer electrolyte layers 304 disposed thereupon is shown during a process of depositing the gel polymer electrolyte 304 onto a substrate 302, in accordance with the methods, procedures, and materials of the present disclosure.

One or more exemplary methods in accordance with the present disclosure may be used to produce portions of or complete biodegradable electrochemical devices as disclosed herein. The methods according to the present disclosure may include providing a biodegradable substrate. The methods may also include depositing an electrode and/or electrode composition adjacent or on the biodegradable substrate. Depositing the electrode may include depositing and drying a current collector of the electrode, and depositing and drying an active layer (i.e., anode or cathode material) adjacent or on the current collector. The method may also include drying the electrode and/or electrode composition. The electrode composition may be dried thermally (e.g., heating). The method may also include depositing a biodegradable, radiatively curable electrolyte composition on or adjacent the electrode composition. The method may further include radiatively curing the biodegradable radiatively curable electrolyte composition. The biodegradable radiatively curable electrolyte composition may be radiatively cured before or subsequent to drying the electrode composition. The biodegradable substrate may be thermally compatible with the optional thermal drying. For example, the biodegradable substrate may be dimensionally stable (e.g., no buckling and/or curling) when thermally drying. The method may include depositing a second electrode and/or electrode composition on or adjacent the biodegradable, radiatively curable electrolyte composition. In at least one embodiment, each of the first and second electrode compositions is a metal foil composition. The metal foil composition of the first electrode may be different from the metal foil composition of the second electrode.

In at least one example, the electrochemical device, all of the components thereof, or substantially all of the components thereof are fabricated via a printing process. The printing process may include depositing, stamping, spraying, sputtering, jetting, coating, layering, or the like. For example, the one or more current collectors, the one or more electrode compositions, the biodegradable, radiatively curable electrolyte composition, or combinations thereof may be deposited via the printing process. Illustrative printing processes may be or include, but are not limited to, one or more of screen printing, inkjet printing, flexography printing (e.g. stamps), gravure printing, off-set printing, airbrushing, aerosol printing, typesetting, roll-to-roll methods, or the like, or combinations thereof. In a preferred embodiment, the components of the electrochemical device are printed via screen printing.

In at least one example, radiatively curing the biodegradable radiatively curable electrolyte composition includes exposing the electrolyte composition to a radiant energy. The radiant energy may be ultraviolet light. Exposing the biodegradable radiatively curable electrolyte composition to the radiant energy may at least partially crosslink the biodegradable radiatively curable electrolyte composition, thereby forming a hydrogel. The biodegradable radiatively curable electrolyte composition may be radiatively cured at room temperature. In at least one embodiment, the biodegradable radiatively curable electrolyte composition is cured at an inert atmosphere. For example, the biodegradable radiatively curable electrolyte composition may be cured under nitrogen, argon, or the like. In another embodiment, the biodegradable radiatively curable electrolyte composition may be cured in a non-inert atmosphere.

In at least one example, the biodegradable radiatively curable electrolyte composition may be radiatively cured in a period of time from about 5 ms to about 100 ms. For example, the biodegradable radiatively curable electrolyte composition may be radiatively cured in a period of time from about 5 ms, about about 10 ms, about 15 ms, about 20 ms, about 30 ms, about 40 ms, or about 50 ms to about 60 ms, about 70 ms, about 80 ms, about 85 ms, about 90 ms, about 95 ms, or about 100 ms. The period of time sufficient to radiatively cure the biodegradable radiatively curable electrolyte composition may be at least partially determined by a power output of the UV light.

As noted herein, in certain molding procedures where a second electrode is applied manually, a fully assembled battery array can exhibit delamination of the polymer gel electrolyte pads from a Zinc active material. This is also reflected in a drop in OCV with the battery failing within hours after manufacturing. In examples, the delamination and failure occurs on the electrode that has been manually applied after curing of the gel polymer electrolyte layer.

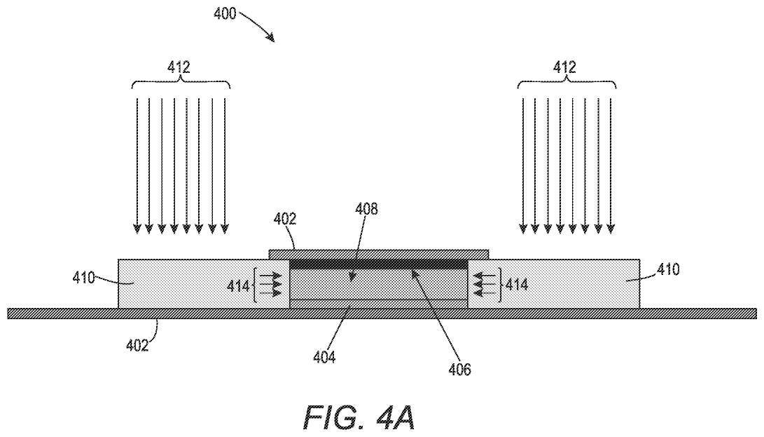

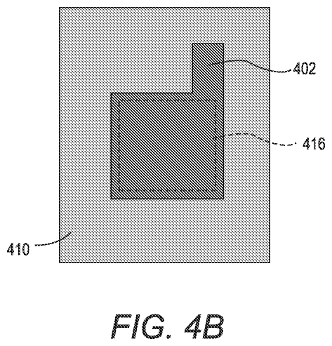

FIGS. 4A-4B illustrate a first process and set up for producing an electrolyte layer of an electrochemical device, in accordance with the present disclosure. A setup for producing an electrolyte layer 400 is shown, where a substrate material 402, both upper and lower versions, having a deposited first or lower electrode layer 404, in this example, an electrode material comprising zinc. Also shown is a second or upper electrode layer 406, in this example, an electrode material comprising manganese oxide, wherein the first electrode layer 404 and the second electrode layer 406 sandwich or encapsulate an electrolyte composition 408. It should be noted that orientation of the electrolytic device in some examples can influence the terminology used to describe which layer can be referred to as the first or second electrode or the upper or lower electrode. It can be further noted that a horizontal orientation of the first or second electrode may also be employed in one or more examples of electrolytic devices fabricated in a similar fashion as described in the present teachings. The first electrode layer 404, second electrode layer 406, and electrolyte composition 408 are held within a light guide mold or gasket 410. The use of a mold material that is capable of both scattering and/or internally reflecting 395 nm light as a light guide is provided. Upon direct exposure to ultraviolet radiation 412, in this example, 395 nm UV light, the incident light is changed to reflected ultraviolet radiation 414, as reflected through the transmissive material of the light guide mold 410 and into the electrolyte composition 408. The mold material guides ultraviolet, or 395 nm, light through an electrolyte pre-cure solution to form a polymer gel electrolyte layer within an electrochemical device. The incident light can be perpendicular to the mold edges, as shown in FIG. 4A, or in an example where there is less scattering the mold material can be angled in a way to increase the internal reflection and thus the output power of the UV light at the mold edges. Example mold materials can include, but are not limited to, light-transmissive materials made from clear or semi-clear rubbers, polymers, plastics, glass, or a combination thereof. FIG. 4B illustrates an upper substrate material 416 from a top-down view configured within the electrolytic device, or battery, in context of the light guide mold 410 and the substrate material 402. It should be noted that the upper or lower substrate material 402 may be similar or different compared to one another depending on the configuration and arrangement of a specific electrolytic device utilizing a method of fabrication as described in regard to FIGS. 4A and 4B.

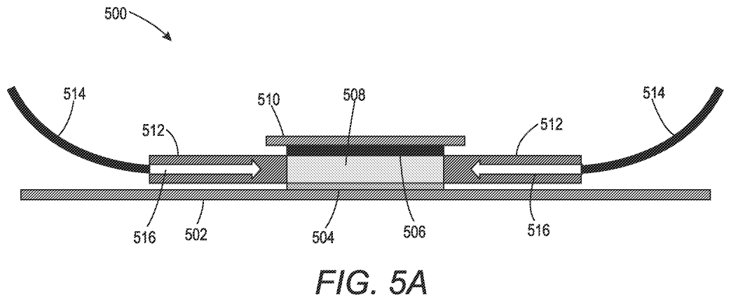

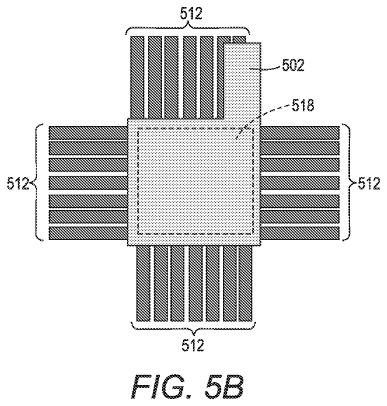

FIGS. 5A-5B illustrate a second process and set up for producing an electrolyte layer of an electrochemical device, in accordance with the present disclosure. A setup for producing an electrolyte layer 500 is shown, where a lower substrate material 502, and an upper substrate 510 material, having a deposited first or lower electrode layer 504, in this example, an electrode material comprising zinc. Also shown is a second or upper electrode layer 506, in this example, an electrode material comprising manganese oxide, wherein the first electrode layer 504 and the second electrode layer 506 sandwich or encapsulate an electrolyte composition 508. It should be noted that orientation of the electrolytic device in some examples can influence the terminology used to describe which layer can be referred to as the first or second electrode or the upper or lower electrode. It can be further noted that a horizontal orientation of the first or second electrode may also be employed in one or more examples of electrolytic devices fabricated in a similar fashion as described in the present teachings. The first electrode layer 504, second electrode layer 506, and electrolyte composition 508 are held within a structured light guide mold or gasket made of one or more fiber optic apertures 512. Upon direct exposure to ultraviolet radiation 516, in this example, 395 nm UV light, via one or more fiber optic elements 514 connected to one or more fiber optic apertures 512, the incident light is transmitted into the electrolyte composition 508. The fiber optic apertures 512 guide ultraviolet, or 395 nm, light through an electrolyte pre-cure solution to form a polymer gel electrolyte layer within an electrochemical device. The incident light can be delivered at one or more angles relative to the mold edges, as formed by the fiber optic apertures 512, as shown in FIG. 5A. Angles or power from the light source can be modified in examples to increase the internal reflection and thus the output power of the UV light delivered to the electrolyte pre-cure solution. This use of an array of microLEDs or LED fiber optic sources as the wall of the mold is one example. In other examples, the microLED modules can be mounted within a clear mold material or individual fiber optic sources can be designed and arranged to form a sealed mold module that would produce a high output 395 nm source at the mold wall threshold. FIG. 5B illustrates an upper substrate material 518 from a top-down view configured within the electrolytic device, or battery, in context of the fiber optic apertures 512 and the substrate material 502. It should be noted that the upper or lower substrate material 502 may be similar or different compared to one another depending on the configuration and arrangement of a specific electrolytic device utilizing a method of fabrication as described in regard to FIGS. 5A and 5B.

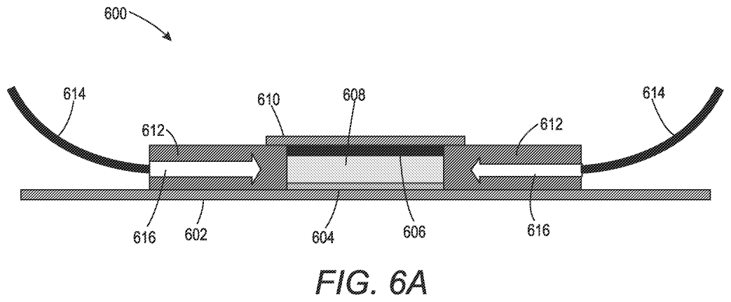

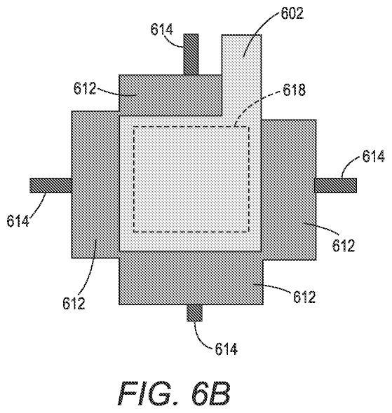

FIGS. 6A-6B illustrate a second process and set up for producing an electrolyte layer of an electrochemical device, in accordance with the present disclosure. A setup for producing an electrolyte layer 600 is shown, where a lower substrate material 602, and an upper substrate 610 material, having a deposited first or lower electrode layer 604, in this example, an electrode material comprising zinc. Also shown is a second or upper electrode layer 606, in this example, an electrode material comprising manganese oxide, wherein the first electrode layer 604 and the second electrode layer 606 sandwich or encapsulate an electrolyte composition 608. It should be noted that orientation of the electrolytic device in some examples can influence the terminology used to describe which layer can be referred to as the first or second electrode or the upper or lower electrode. It can be further noted that a horizontal orientation of the first or second electrode may also be employed in one or more examples of electrolytic devices fabricated in a similar fashion as described in the present teachings. The first electrode layer 604, second electrode layer 606, and electrolyte composition 608 are held within a structured light guide mold or gasket made of one or more planar wave guides 612. Upon direct exposure to ultraviolet radiation 616, in this example, 395 nm UV light, via one or more fiber optic elements 614 connected to one or more planar wave guides 612, the incident light is transmitted into the electrolyte composition 608. The planar wave guides 612 direct ultraviolet, or 395 nm, light through an electrolyte pre-cure solution to form a polymer gel electrolyte layer within an electrochemical device. The incident light can be delivered at one or more angles relative to the mold edges, as formed by the planar wave guides 612, as shown in FIG. 6A. These planar fiber optic modules provide both emission sources and mold walls on each of the four sides of the device. Angles or power from the light source can be modified in examples to increase the internal reflection and thus the output power of the UV light delivered to the electrolyte pre-cure solution. This use of the described thin planar LED fiber optic sources as the wall of the mold provides another example. In other examples, the thin planar LED fiber optic sources can be mounted within a clear mold material or individual fiber optic sources can be designed and arranged to form a sealed mold module that would produce a high output 395 nm source at the mold wall threshold. FIG. 6B illustrates an upper substrate material 618 from a top-down view configured within the electrolytic device, or battery, in context of the planar wave guides 612 and the substrate material 602. It should be noted that the upper or lower substrate material 602 may be similar or different compared to one another depending on the configuration and arrangement of a specific electrolytic device utilizing a method of fabrication as described in regard to FIGS. 6A and 6B.

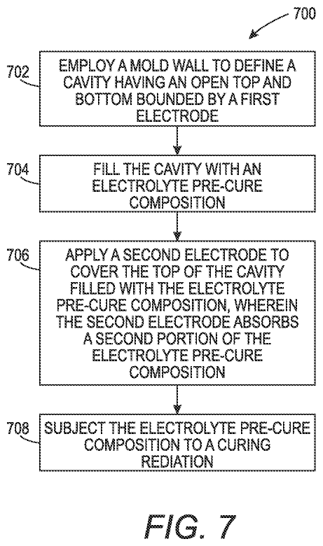

FIG. 7 is a flowchart illustrating a method for producing an electrolyte layer of an electrochemical device, in accordance with the present disclosure. A method of producing an electrolyte layer of an electrochemical device 700 includes employing a mold wall to define a cavity having an open top and a bottom bounded by a first electrode 702. At least a portion of the mold wall is transmissible to a curing radiation. Next, the cavity is filled with an electrolyte pre-cure composition wherein the first electrode absorbs a first portion of the electrolyte pre-cure composition 704. A second electrode (opposite electrode) is introduced to cover the top of the cavity filled with the electrolyte pre-cure composition, wherein the second electrode absorbs a second portion of the electrolyte pre-cure composition 706, and electrolyte pre-cure composition is subjected to a curing radiation via the portion of the mold wall transmissible to the curing radiation to initiate crosslinking of the electrolyte pre-cure composition to form a cured electrolyte composition 708. This can be completed such that the second electrode is in contact with a top surface of the deposited electrolyte composition, and at least a portion of the electrolyte composition absorbs into at least a portion of the second, opposite electrode. The method of producing an electrolyte layer of an electrochemical device 700, can include, but is not limited to, wherein the curing radiation comprises ultraviolet radiation. In certain implementations, the mold wall scatters or internally reflects ultraviolet radiation towards the cavity, which can provide a more effective exposure of the pre-cure composition to the curing radiation when applied. In some examples, as previously described herein, the mold wall can include or be a source that produces curing radiation. In implementations, the method of producing an electrolyte layer of an electrochemical device 700 further includes additional steps of applying a uniform pressure to a top surface of the second electrode prior to subjecting the electrolyte pre-cure composition to the curing radiation, removing the uniform pressure applied to the top surface of the second electrode after forming the cured electrolyte composition, and removing the one or more mold walls from the substrate after curing takes place.

Further preparation of the mold wall and other components of the assembly used in the method 700 can include the application of an adhesive, a solvent cleaning, an abrasive cleaning, or a surface treatment, such as corona treatment or plasma treatment, or a combination thereof. In examples, a transmissive or transparent to curing radiation material comprising glass, plastic, polymer such as silicone, ceramic, or other material is placed on the substrate in the form of the electrolyte layer. In other examples, including those described herein, the mold wall is formed or prepared by placement of one or more planar wave guides, one or more fiberoptic elements, such as fiber optic apertures, or combinations thereof. In examples, heat or other radiation, such as infrared, x-ray, or gamma ray radiation may be directed towards the electrolyte composition. A combination of one or more of the described methods or apparatus can be used in a single procedure. In examples, power of light and penetration through a layer may provide variability in one or more parameters in the aforementioned methods. As thickness is smaller, a higher power light source may be necessary to penetrate through one or more side apertures. In certain examples, residual or unreacted photoinitiator may be present in the formed electrolyte layer. In other examples, the uncured electrolyte layer being enclosed in a sealed structure may undergo reduced oxygen inhibition as the electrolyte composition is cured in a closed space. The extent of cure can be superior since it is a closed system. It should be noted that the translucence of a mold or gasket or other material for transmitting UV light may have different refractive indices, which can impact efficiency of the UV light delivered to cure the electrolyte composition.

Examples of the present disclosure include aqueous electrolyte compositions, or alternatively non-aqueous or organic based electrolyte compositions. In examples, the electrolyte composition includes a gel polymer electrolyte, which can include a hydrogel of a copolymer and a salt dispersed in the hydrogel of a copolymer, such as those described herein in further detail. In examples, non-hydrogel, organic electrolyte materials may be used. Illustrative examples of non-hydrogel organic electrolyte materials include PEG (polyethylene glycol) liquid electrolytes. Nonaqueous electrolytes including lithium-based salt electrolytes can be used, such as those formulated by dissolving lithium salts such as lithium hexafluorophosphate (LiPF₆) in organic carbonate solvents such as mixtures of ethylene carbonate (EC) with dimethyl carbonate (DMC), propylene carbonate (PC), diethyl carbonate (DEC), and/or ethyl methyl carbonate (EMC). Nonaqueous electrolyte solutions can be produced in inorganic and organic solutions. An example of an inorganic electrolyte is lithium aluminum chloride (LiAlCl₄) dissolved in thionyl chloride. An organic electrolyte can include a solution of a lithium salt and an organic solvent. The organic solvent must be aprotic in order to avoid reaction with lithium and should have a high dielectric constant to dissolve sufficient quantities of lithium salt. Mixtures of two or more organic solvents can also be used to provide good solvent properties. Illustrative lithium salts include lithium perchlorate (LiClO₄), lithium tetrafluoroborate (LiBF₄), lithium trifluoromethane sulfonate (LiCF₃SO₃), and the like. Electrochemical devices of the present disclosure can include wherein the electrolyte composition includes an aqueous-based electrolyte composition or an organic electrolyte composition.

Methods and examples of the present disclosure provide an in-situ molding and radiative curing of a polymer gel electrolyte within a stacked electrode battery architecture, which eliminates manual application of electrode to electrolyte as well as the disadvantages thereof. In these examples, the adhesion between polymer gel electrolyte and electrodes can be markedly improved, and also providing improved mechanical robustness and flexibility without any loss of OCV or early battery failure due to delamination. The provided process can be flexible to numerous material and system options that guide 395 nm light internally through the battery. In other aspects of the present disclosure, the manufacturing of a stacked electrode architecture thin film battery is conducted by radiatively curing a polymer gel electrolyte within an assembled and enclosed electrode stack by using guided UV light or UV laser light, in some examples, 395 nm light. While shown in battery applications, the present disclosure can further be applied to a wide variety of electrochemical devices that require a stacked architecture where a gel electrolyte material is arranged within an enclosed space. In examples, the highly sensitive curing ability (<500 ms single pulse @ 10 cm distance) of exemplary biodegradable polymer gel electrolytes, even at multiple centimeters in thickness, provides an enabling feature for long distance curing of a gel electrolyte through a thin flat enclosed space.

A significant advantage of the methods and devices of the present teachings as compared to previous methods is that in fabricating electrochemical devices using previously known methods, a point of failure could manifest in one or more boundary layers between the electrolyte layer and one or more electrodes caused by poor adhesion of the electrolyte layer to an electrode. That is to say, a failure occurring in an electrochemical device provided by the described method of the present teachings would be less likely to demonstrate such a delamination failure, due to the impregnation of an electrolyte layer into the structure of the electrode. This can be explained by interpenetration of an electrolyte pre-cure solution into the electrodes of an electrochemical device prior to curing, resulting in a more substantial adhesive bonding between an electrolyte gel layer and the electrodes. Examples of the electrochemical devices and methods described herein can be detectable by the electrolyte pre-cure solution being soaked or having interpenetrated into both electrodes (electrodes are particles within a binder) as compared to curing an electrolyte layer prior to adhesion steps, as the electrolyte would soak into the gaps of the electrode and be impregnated or interpenetrating rather than just be superficially adhered. A range of the thickness of the electrodes (active layer) can be from about 15 microns to about 60 microns, or in certain examples 100 microns.

### Examples

Materials used in examples of the present disclosure include PLA, 75 micron (Celplast), CI-2042 Carbon ink (Nagase Group), Zn powder (Grillo Alloy), MnO₂ powder (Sigma Aldrich), graphite (Sigma Aldrich), pre-cure solution of polymer gel electrolyte, sodium alginate (Sigma Aldrich). Equipment used includes a manual desktop screen printer (ACS365), an 80 durometer squeegee, opaque silicone rubber sheets (0.7 mm from McMaster-Carr), semi-clear silicone rubber sheets (3 mm, 0.7 mm from McMaster-Carr), Phoseon 16W FJ200 UV lamp (395 nm), ⅛″ steel shot, and heavy clear glass sheet (1.5 mm thick).

### Comparative Example

The following example describes a standard process for forming a small three-cell battery comprising a polymer gel electrolyte for a comparative example of a compostable battery.

Current Collector: 80 micron thick PLA substrate is pinned to an aluminum tray using polyimide (Kapton™) tape in order to prevent dimensional shifts when heated. Alternatively, PLA-D bi-axially stretched may be used without the need for pinning. CI-2042 (Nagase Group) Carbon ink was screen printed onto 80-micron PLA substrate using a 180-mesh nylon screen with an 80-durometer squeegee and a 1.5 mm off screen gap. The carbon layer was cured at 100° C. for 9 min in a forced air oven to produce a 6-8 micron layer. Separate current collectors were printed for Zn and MnO₂. The Kapton™ tape was then removed.

Alginate Solution: Alginate solution was prepared in a 20 mL vial, with a small magnetic stir rod. To the vial was added 1 g of sodium alginate (from brown algae, Sigma Aldrich) and 18 mL DI water into vial. Beginning from room temperature, the contents were heated over a hotplate using a double boiler method. The water bath was maintained at approximately 90° C. until all alginate inside the vial was fully dissolved: then the alginate was cooled down to room temperature

Zn Paste: In an attritor bowl, 100 g of stainless steel shot were added. Next was added 2.5 g glycerol to wet the steel shot. 98 g Zn (Grillo alloy) was added with 16.5 mL alginate solution and stirred with a spatula and mounted to an attritor. This was left overnight. 0.5-1 mL DI water and/or glycerol was added, depending on the environment with respect to temperature, relative humidity, etc. The sample was collected using a sieve to retain the stainless steel shot.

MnO₂ Paste: In an attritor bowl, 100 g stainless steel shot was added. Next was added 2.5 g glycerol to wet the steel shot. 5.35 g graphite and 21.38 g MnO₂ (Reagent, Aldrich) was added with 9 mL DI water and 5 mL alginate solution. This was stirred and mounted to an attritor, then left overnight. 0.5-1 mL DI water and/or glycerol was added, depending on the environment with respect to temperature, relative humidity, etc. The sample was collected using a sieve to retain the stainless steel shot.

Active Lavers (Zn and MnO₂): Active layers (Zn and MnO₂) were separately screen printed onto the current collector using an 80-mesh (30-40 micron thick print layer) or 60-mesh (50-60 micron thick print layer) using an 80-durometer squeegee and on-contact printing (zero gap). Active layers were cured at 100° C. for PLA for 9 min in a forced air oven to produce a 40-60 micron layer depending on the screen mesh used.

Polymer Gel Electrolyte Layer: Using a 700-micron thick rubber gasket mold with a 40 mm×12.5 mm aperture, the mold was placed over a Zn side electrode and then liquid pre-cure electrolyte solution was dropped into the mold with about a 5 mm gap between liquid and mold edges. Placed a clear PLA sheet over the liquid in the mold to act as a release layer, careful not to introduce bubbles. Placed a heavy clear glass 1.5 mm thick over the PLA sheet to squeeze the liquid fully into the mold. Cured using a Phoscon 16W 395 nm lamp for 500 ms at 10 cm distance. Removed glass and PLA sheet. Removed Zn electrode with cured polymer gel electrolyte pad from the rubber gasket. Manually placed the MnO₂ electrode face down onto the cured gel electrolyte on the Zn electrode with application of uniform pressure to create contact between the polymer gel electrolyte surface and the MnO₂ surface.

Sealing (optional): The assembled battery can optionally be heat sealed along the edges of exposed PLA, or can be placed into a metalized battery pouch and heat sealed, or both. For the purposes of this disclosure, the battery was not sealed in order to qualitatively observe the adhesion between the manually applied MnO₂ layer and the polymer gel electrolyte surface.

### Example 1

The following example is a process for forming a battery comprising a polymer gel electrolyte for a compostable battery. A thicker mold gasket was used to enable improved visualization of any remaining uncured pre-cure solution within the center of the battery. All procedures are the same as the Comparative Example except the following:

A 3 mm thick semi-clear silicone rubber gasket having the same aperture dimensions was used in place of the 700-micron opaque rubber gasket: the MnO₂ electrode was cut to size that enabled it to be pushed through the mold aperture: the cut to size MnO₂ electrode was placed onto the surface of the pre-cure solution poured into the mold prior to curing as opposed to after curing; and the Phoseon 16W UV light source was turned on for 1000 ms instead of 500 ms.

A fully assembled battery with cured polymer gel electrolyte between the Zn and MnO₂ electrodes was removed from the rubber gasket by pushing the MnO₂ side through the aperture. Firm pressure can be applied without any collapse of the interior of the battery suggesting the curing is throughout the interior.

### Example 2

The following example is a process for forming a battery comprising a polymer gel electrolyte for a compostable battery. The semi-clear mold gasket was reduced to the same thickness of the rubber gasket used in Comparative Example 1 in order to make a fully functional battery. All procedures are the same as Example 1 except the following:

A 700-micron thick semi-clear silicone rubber gasket having the same aperture dimensions was used in place of the 3000-micron (3 mm) gasket used in Example 1. Similar to example 1, the 700-micron semi-clear silicone gasket was used to mold a polymer gel electrolyte in-situ wherein both the top and bottom electrodes are in contact with the pre-cure solution during curing. The result is a robustly adhered electrodes on both sides of the battery. Firm pressure can be applied without any shorting occurring.

By contrast, the Comparative Example produced a battery where the adhesion between the active layer and the cured polymer gel electrolyte was weak and easily delaminated under mild handling. Both Example 1 and Example 2 produce robustly adhered electrode-electrolyte interfaces that could only be delaminated by destroying either the active layer or the polymer electrolyte gel by significant force.

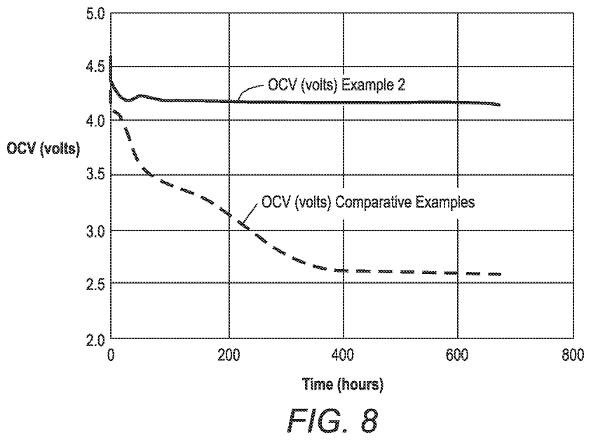

OCV stability: The Comparative Example along with Example 2 were placed into an aluminized battery pouch to prevent water loss due to evaporation. The OCV was measured each day at the same time to observe any changes over time, as shown in Table 2 and FIG. 8. FIG. 8 is a plot depicting OCV change over time of Comparative Example and Example 2. The Comparative Example, wherein a manual application of electrode to the polymer electrolyte was used, shows a precipitous drop in OCV over time. This is presumably a result of poor contact between the polymer electrolyte surface and the electrode material. Example 2, wherein an in-situ curing of polymer gel electrolyte occurs within the fully assembled battery, shows a stable OCV over time.

TABLE 2
OCV change over time of Comparative Example and Example 2

| | Comparative Example | Example 2 |
|---|---|---|
| Time After | OCV (volts)-Manual | OCV (volts)-In-situ |
| Assembly | Application of Polymer Gel | Curing of Polymer Gel |
| (hours) | Electrolyte | Electrolyte |
| 0 | 4.45 | 4.59 |
| 1 | 4.25 | 4.45 |
| 2 | 4.15 | 4.41 |
| 3 | 4.12 | 4.37 |
| 4 | 4.09 | 4.29 |
| 24 | 3.95 | 4.18 |
| 48 | 3.58 | 4.22 |
| 96 | 3.41 | 4.18 |
| 168 | 3.25 | 4.17 |
| 336 | 2.68 | 4.14 |
| 504 | 2.61 | 4.16 |
| 672 | 2.58 | 4.14 |

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

1. An electrochemical device, comprising:
an anode;
a cathode; and
a cured electrolyte composition disposed between the anode and the cathode; wherein:
at least a portion of the electrolyte composition interpenetrates at least a portion of both the anode and the cathode; and
the cathode and the anode exhibits a stacked geometry.

2. The electrochemical device of claim 1, wherein the cured electrolyte composition is a single layer without an interface.

3. The electrochemical device of claim 1, wherein the cured electrolyte composition comprises a gel polymer electrolyte.

4. The electrochemical device of claim 3, wherein the gel polymer electrolyte comprises a hydrogel of a copolymer and a salt dispersed in the hydrogel of a copolymer.

5. The electrochemical device of claim 1, wherein the cured electrolyte composition comprises a biodegradable electrolyte composition.

6. The electrochemical device of claim 1, wherein the cured electrolyte composition comprises an aqueous-based electrolyte composition.

7. The electrochemical device of claim 1, wherein the cured electrolyte composition comprises a non-aqueous electrolyte composition.

8. The electrochemical device of claim 1, wherein the cured electrolyte composition comprises an organic electrolyte composition.

9. The electrochemical device of claim 7, wherein the cured electrolyte composition further comprises a lithium salt.

10. A stacked geometry electrochemical device, comprising:
a first electrode:
a second electrode:
a cured electrolyte composition defining a top surface in contact with the first electrode, a bottom surface in contact with the second electrode, and a peripheral edge not in contact with the first electrode and the second electrode; and
a mold wall disposed at the peripheral edge surrounding and contacting the cured electrolyte composition, wherein at least a portion of the mold wall is transmissible to curing radiation.

11. The stacked geometry electrochemical device of claim 10, wherein the cured electrolyte composition is a single layer without an interface.

12. The stacked geometry electrochemical device of claim 10, wherein the cured electrolyte composition comprises a gel polymer electrolyte.

13. The stacked geometry electrochemical device of claim 10, wherein the cured electrolyte composition comprises a biodegradable, aqueous-based electrolyte composition.

14. The stacked geometry electrochemical device of claim 10, wherein the cured electrolyte composition comprises a non-aqueous, organic electrolyte composition.

15. A method of producing an electrolyte layer of an electrochemical device, comprising:
employing a mold wall to define a cavity having an open top and a bottom bounded by a first electrode, wherein at least a portion of the mold wall is transmissible to a curing radiation;
filling the cavity with an electrolyte pre-cure composition wherein the first electrode absorbs a first portion of the electrolyte pre-cure composition:
applying a second electrode to cover the top of the cavity filled with the electrolyte pre-cure composition, wherein the second electrode absorbs a second portion of the electrolyte pre-cure composition; and
subjecting the electrolyte pre-cure composition to a curing radiation via the portion of the mold wall transmissible to the curing radiation to initiate crosslinking of the electrolyte pre-cure composition to form a cured electrolyte composition.

16. The method of producing an electrolyte layer of an electrochemical device of claim 15, wherein the curing radiation comprises ultraviolet radiation.

17. The method of producing an electrolyte layer of an electrochemical device of claim 15, wherein the mold wall scatters or internally reflects ultraviolet radiation towards the cavity.

18. The method of producing an electrolyte layer of an electrochemical device of claim 15, wherein the mold wall comprises a source that produces curing radiation.

19. The method of producing an electrolyte layer of an electrochemical device of claim 15, further comprising:
applying a uniform pressure to a top surface of the second electrode prior to subjecting the electrolyte pre-cure composition to the curing radiation;
removing the uniform pressure applied to the top surface of the second electrode after forming the cured electrolyte composition; and
removing the one or more mold walls from the substrate.

20. The method of producing an electrolyte layer of an electrochemical device of claim 15, wherein the electrolyte pre-cure composition comprises a gel polymer electrolyte, comprising a hydrogel of a copolymer and a salt dispersed in the hydrogel of a copolymer.
